(19) United States
(12) Patent Application Publication
(10) Pub. No.: US 2023/0130415 A1
(43) Pub. Date: Apr. 27, 2023

(54) TRANSMISSION SPEED CHANGE CONTROL SYSTEM

(71) Applicant: Xiang ZHOU, Chongqing (CN)

(72) Inventor: Xiang ZHOU, Chongqing (CN)

(21) Appl. No.: 17/946,436

(22) Filed: Dec. 1, 2022

Related U.S. Application Data
(63) Continuation-in-part of application No. PCT/CN2020/079430, filed on Mar. 16, 2020.

(51) Int. Cl. F16H 61/662

(52) U.S. Cl. CPC F16H 61/6625

(57) ABSTRACT

A transmission speed change control system using effective torque force as a master control parameter instead of throttle percentage signal and engine speed signal. Response time of this system is extremely shorter than existing system, therefore, when this transmission speed change control system is used in cooperation with a continuously variable transmission, the real-time speed ratio matching, can be realized, and the transmission system is maintained in an optimal working condition at any time, so as to improve the transmission efficiency of the transmission system. Meanwhile, the load of the power source can be adjusted without abrupt change. Hence, the work efficiency of the power source is improved, and the service life thereof is prolonged. At the same time, compared with the existing transmission system, the composition and control logic of this control system are simpler and more efficient, and easier to calibrate and adjust.

### TECHNICAL FIELD

The present invention relates to a transmission speed change control system, in particular to a control system for controlling gear ratio matching of a torque transmission mechanism.

### BACKGROUND

At present, all speed change control systems used by automatic transmission vehicles collect the data of vehicle engine speed, throttle percentage, and input speed and output speed of a transmission by sensors, and these data are then input into a shift logic control processor for calculation, so as to obtain a shift instruction, which is converted into a mechanical shift action, thus realizing the automatic shift process.

Rotary transmission systems feature a complicated speed relationship, many control input conditions and long time for shifting instructions to be converted into mechanical shift actions. Therefore, such speed control systems can only select a limited number of gears to perform shift control under the condition of high efficiency, but cannot realize real-time shift control of infinite gears. This results in an obviously stepped curve of matching of engine output efficiency and transmission efficiency, adjacent gear states show obvious differences, and an engine is in an inefficient working state most of the time, so the system cannot be maintained in an optimal working condition all through.

### Technical Problem

The purpose of the present invention is to create a speed change control system which can realize real-time speed ratio matching, and enables a mechanical transmission structure to be maintained in an optimal transmission condition at any time within a gear ratio adjustment range, so as to improve the transmission efficiency and shift smoothness of a mechanical rotation system.

### Technical Solution

To achieve the above objective, the present invention provides the following technical scheme. A transmission speed change control system using effective torque force as a master control parameter includes a power input structure, a driven structure, an effective torque force monitoring and feedback device, an effective torque force feedback signal transmission structure, a gearshift and a transmission. Auxiliary devices such as a torque force adjusting device, a torque force buffering device and a torque force feedback signal processing unit can be selectively added according to specific situations.

(New term definition) Effective torque force: A torque transmission process involves complicated stress states, and the force that effectively acts on a driven member to transmit torque is called effective torque force.

The power input structure is a power input transmission mechanism of the system.

The power output structure is a power output transmission structure of the system.

The power source is a power source of the system and can be any type of power device or structure that can generate torque.

The driven structure is a power output target of the system.

The torque force is the acting force when the power input structure transmits power to the driven structure.

The effective torque force monitoring and feedback device can monitor the effective torque force in the torque transmission process between the power input structure and the transmission and generate feedback signals, and the commonly used feedback signals include hydraulic signals, voltage signals, displacement signals and the like.

The effective torque force feedback signal transmission structure can transmit the effective torque force feedback signals generated by the torque force monitoring and feedback device to the gearshift.

The gearshift can control the transmission to make corresponding gear shifting actions according to the effective torque force signals.

The transmission can change the rotating speed and torque transmitted from the power input source to the driven structure, and can change a gear ratio between the power input source and the driven structure.

The torque force adjusting device can adjust the effective torque force, thereby adjusting torque transmission efficiency.

The torque force buffering device can buffer the effective torque force, eliminate sudden change of the torque force, ensure smooth change of the torque force, and avoid redundant gear shifting actions caused by sudden change of the torque force.

The torque force feedback signal processing unit can filter and further process the effective torque force feedback signals, for example, eliminating interference signals; amplifying main control signals; correcting the torque force feedback signals according to auxiliary signals such as rotating speed; and converting the torque force feedback signals into gearshift driving signals.

In this system, the signal of effective torque force is used as a core control signal of speed change control, and the effective torque force monitoring and feedback device is used to convert the continuously changing signals of effective torque force generated in the process of transmission between the power input structure and the driven structure into the continuously changing feedback signals; and based on actual needs, by means of auxiliary devices such as the torque force adjusting device, the torque force buffering device and the torque force feedback signal processing unit, the feedback signals are subjected to auxiliary processing such as sudden change elimination, correction, amplification, and conversion then to be converted into the driving signals, which are transmitted to the gearshift, such that the gearshift performs gear shifting operation according to the driving signals.

### BENEFICIAL EFFECTS

When this transmission speed change control system is used in cooperation with a continuously variable transmission, the real-time speed ratio matching can be realized, and the transmission system is maintained in an optimal working condition at any time, so as to improve the transmission efficiency of the transmission system.

The load of the power input source can be adjusted without abrupt change. Hence, the work efficiency of the power input source is improved, and the service life thereof is prolonged.

Compared with the existing system, the composition and control logic of this system are simpler and more efficient.

Instead of using throttle percentage signals, engine speed signals, and tire speed signals as necessary parameters for speed change control, only the effective torque force signals generated by the effective torque force monitoring and feedback device are needed to control gear matching. Compared with the existing transmission system, the configuration is simpler and easier to calibrate and adjust.

The system can be realized with only mechanical and hydraulic adaptive control, without any electronic transmission control unit, so as to avoid failures caused by circuit failure.

The gear shifting response speed of the system according to the real-time working condition is much faster than current existing transmission speed change control system.

### BRIEF DESCRIPTION OF DRAWINGS

The illustrated embodiment is only one of many implementations of the present invention. Other than basic system components, auxiliary system components can be added or removed according to actual needs.

### PREFERRED EMBODIMENTS OF THE PRESENT INVENTION

The transmission in the system is a continuously variable transmission so as to realize accurate matching of the optimal gear ratio all the time

### DETAILED DESCRIPTION

The present invention will be further explained with the following embodiment.

It should be noted that the following embodiment is only one of many implementations of the present invention.

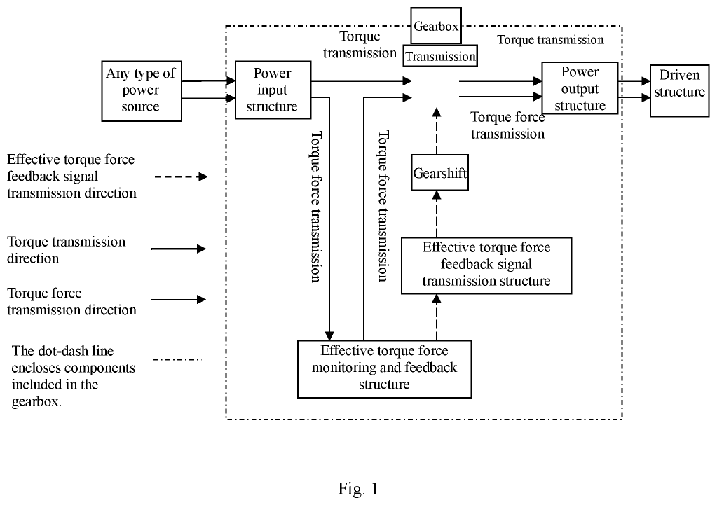

A system in the embodiment as shown in FIG. 1 consists of a power input structure, an effective torque force monitoring and feedback structure, an effective torque force feedback signal transmission structure, a gearshift, a transmission, a driven structure, a power output structure etc.

The power input structure is connected with both the effective torque force monitoring and feedback structure and the transmission. The effective torque force monitoring and feedback structure transmits effective torque force monitoring signals to the gearshift through the effective torque force feedback signal transmission structure, and the gearshift performs corresponding gear shifting actions according to the effective torque force monitoring signals to change a gear ratio of the transmission, such that the gear ratio of the transmission is matched with the motion state of the power input source and the driven structure.

### INDUSTRIAL APPLICABILITY

The system can be used in a scenario of matching a gear ratio for the power source of changing output torque involving speed ratio change control, such as: engine matching transmission, and speed ratio control of electro-motor in hydraulic servo.

1. A transmission speed change control system, comprising: a power input structure, a output structure, an effective torque force monitoring and feedback device, an effective torque force feedback signal transmission structure, a gearshift and a transmission, wherein an effective torque force monitoring and feedback structure is provided.

2. The transmission speed change control system of claim 1, wherein an effective torque force is used as a master control parameter, instead of using a throttle percentage signal, an engine speed signal, a vehicle speed signal or an engine crankshaft torque signal.
